(19) United States
(12) Patent Application Publication
(10) Pub. No.: US 2025/0018301 A1
(43) Pub. Date: Jan. 16, 2025

(54) SYSTEM, METHOD, AND INFORMATION STORAGE MEDIUM

(71) Applicant: Rakuten Group, Inc., Tokyo (JP)

(72) Inventors: Yuki NIWA, Tokyo (JP); Tamaki Kontani, Tokyo (JP); Ryuki Uenaka, Tokyo (JP); Yuki Tanaka, Tokyo (JP)

(73) Assignee: Rakuten Group, Inc., Tokyo (JP)

(21) Appl. No.: 18/769,621

(22) Filed: Jul. 11, 2024

(30) Foreign Application Priority Data
Jul. 12, 2023 (JP) 2023-114480

(51) Int. Cl. A63F 13/69; A63F 13/79; G06Q 30/0207; G06Q 30/0601

(52) U.S. Cl. CPC A63F 13/69; A63F 13/79; G06Q 30/0209; G06Q 30/0633

(57) ABSTRACT

Provided is a system including at least one processor configured to: execute a game based on user's actions; determine whether a predetermined condition associated with one of a product or a service in electronic commerce is satisfied based on the user's actions in the game; and execute processing for listing one of the product or the service with a candidate list of a user account of the user in the electronic commerce when the predetermined condition is determined to be satisfied.

### CROSS-REFERENCE TO RELATED APPLICATION

The present application claims priority from Japanese application JP 2023-114480 filed on Jul. 12, 2023, the content of which is hereby incorporated by reference into the application.

### BACKGROUND OF THE INVENTION

### 1. Field of the Invention

The present disclosure relates to a system, a method, and an information storage medium.

### 2. Description of the Related Art

Hitherto, there has been known electronic commerce which enables commerce relating to a product or a service through use of electronic means. For example, in JP 2003-030469 A, there is described a product sales system that uses a virtual department store using a virtual reality space, and includes a server device for achieving the virtual department store in the virtual reality space corresponding to a department store existing in the real world, and a product information database which is connected to the server device such that the server device can make access to the product information database.

### SUMMARY OF THE INVENTION

However, with the technology of JP 2003-030469 A, a user simply repeats shopping experience in usual electronic commerce in the virtual department store in the virtual reality space. Thus, the user enjoys only shopping in the virtual department store. With related art other than JP 2003-030469 A as well, the user principally enjoys only shopping, and hence the related-art technology cannot sufficiently increase entertainment for the user.

One object of the present disclosure is to increase entertainment for a user having a user account in electronic commerce.

According to at least one embodiment of the present disclosure, there is provided a system including at least one processor configured to: execute a game based on a user's actions in the game of a user; determine whether a predetermined condition associated with one of a product or a service in electronic commerce is satisfied based on the user's actions in the game; and execute processing for listing one of the product or the service with a candidate list of a user account of the user in the electronic commerce when the predetermined condition is determined to be satisfied.

### BRIEF DESCRIPTION OF THE DRAWINGS

FIG. 1 is a diagram for illustrating an example of a hardware configuration of a system according to at least one embodiment of the present disclosure.

FIG. 2 is a view for illustrating an example of a scene in which a user plays a game.

FIG. 3 is a view for illustrating an example of a shopping cart screen.

FIG. 4 is a diagram for illustrating an example of functions implemented in the at least one embodiment.

FIG. 5 is a table for showing an example of a user database in the game.

FIG. 6 is a table for showing an example of a condition database.

FIG. 7 is a table for showing an example of a user database in electronic commerce.

FIG. 8 is a table for showing an example of a product database.

FIG. 9 is a diagram for illustrating an example of processing executed in a game system and the like.

FIG. 10 is a diagram for illustrating an example of functions implemented in modification examples of the present disclosure.

FIG. 11 is a view for illustrating an example a game executed in Modification Example 1 of the present disclosure.

FIG. 12 is a view for illustrating an example a game executed in Modification Example 2 of the present disclosure.

FIG. 13 is a view for illustrating an example of an end screen in Modification Example 3 of the present disclosure.

FIG. 14 is a view for illustrating an example of the end screen in Modification Example 3.

FIG. 15 is a view for illustrating an example of a game screen in Modification Example 7 of the present disclosure.

FIG. 16 is a view for illustrating an example a game executed in Modification Example 8 of the present disclosure.

### DETAILED DESCRIPTION OF THE INVENTION

### 1. Hardware Configuration of System

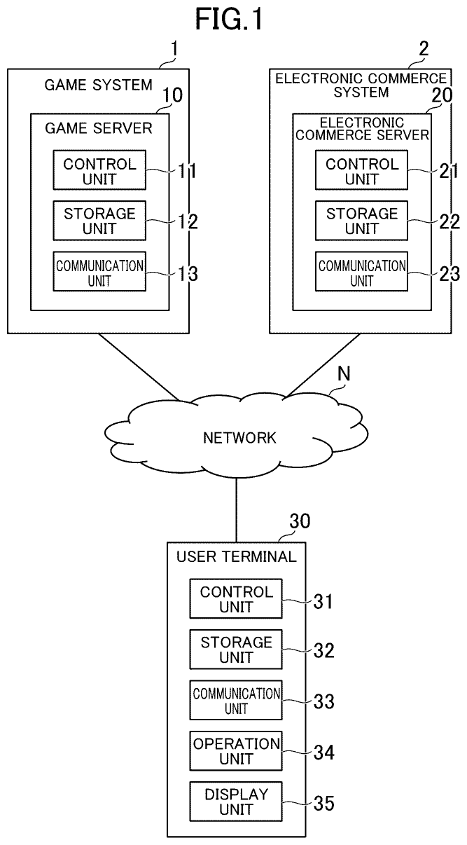

Description is now given of an example of at least one embodiment of a system, a method, and a program according to the present disclosure. FIG. 1 is a diagram for illustrating an example of a hardware configuration of the system according to the at least one embodiment. In the at least one embodiment, there is exemplified a case in which a game system 1 corresponds to the system according to the present disclosure. Thus, a portion described as the game system 1 can be read as the system according to the present disclosure. In the example of FIG. 1, each of the game system 1, an electronic commerce system 2, and a user terminal 30 is connected to a network N such as the Internet or a LAN.

For example, the game system 1 is a system of a game provider which provides a game to a user. In the at least one embodiment, there is exemplified a case in which a browser game executed on a browser of the user terminal 30 corresponds to the game, but the game may be of any type and is not limited to the example of the at least one embodiment. For example, the game may be a game (for example, so-called smartphone game) executed on a game program installed on the user terminal 30, a game executed on a game machine (for example, game machine in an amusement facility) other than the user terminal 30, or a game of another type.

For example, the game system 1 includes a game server 10 which is a server computer. The game server 10 includes a control unit 11, a storage unit 12, and a communication unit 13. The control unit 11 includes at least one processor. The storage unit 12 includes at least one of a volatile memory such as a RAM or a nonvolatile memory such as a flash memory. The communication unit 13 includes at least one of a communication interface for wired communication or a communication interface for wireless communication.

For example, the electronic commerce system 2 is a system of an electronic commerce provider which provides electronic commerce to the user. The electronic commerce is commerce executed through use of electronic means. In the electronic commerce, not only a product, but also a service may be a target of the commerce. In the at least one embodiment, there is exemplified a case in which the game provider and the electronic commerce provider are different from each other, but the game provider and the electronic commerce provider may be the same. That is, the same party may provide both of the game and the electronic commerce to the user.

In the at least one embodiment, there is exemplified a case in which online shopping (Internet shopping) corresponds to the electronic commerce, but the electronic commerce may be of any type, and is not limited to the example in the at least one embodiment. For example, an online flea market or an online shopping mall in which a plurality of member stores are opened may correspond to the electronic commerce. For example, a service which receives a reservation through electronic means also corresponds to the electronic commerce, and hence an online reservation for a facility such as a hotel or a beauty salon, a travel product such as a tour, or a ticket for a transportation facility such as an airplane or a concert or the like may correspond to the electronic commerce.

For example, the electronic commerce system 2 includes an electronic commerce server 20 which is a server computer. The electronic commerce server 20 includes a control unit 21, a storage unit 22, and a communication unit 23. Hardware configurations of the control unit 21, the storage unit 22, and the communication unit 23 may be the same as those of the control unit 11, the storage unit 12, and the communication unit 13, respectively.

For example, the user terminal 30 is a computer of the user. For example, the user terminal 30 is a smartphone, a tablet computer, a personal computer, or a wearable terminal. For example, the user terminal 30 includes a control unit 31, a storage unit 32, a communication unit 33, an operation unit 34, and a display unit 35. Hardware configurations of the control unit 31, the storage unit 32, and the communication unit 33 may be the same as those of the control unit 11, the storage unit 12, and the communication unit 13, respectively. The operation unit 34 is an input device such as a touch panel or a mouse. The display unit 35 is a display such as a liquid crystal display or an organic EL display.

Programs stored in the storage units 12, 22, and 32 may be supplied to the game server 10, the electronic commerce server 20, or the user terminal 30, respectively, via the network N. Moreover, at least one of a reading unit (for example, a memory card slot) for reading a computer-readable information storage medium or an input/output unit (for example, a USB port) for inputting/outputting data from/to an external device may be included in the game server 10, the electronic commerce server 20, or the user terminal 30. For example, a program stored in an information storage medium may be supplied to the game server 10, the electronic commerce server 20, or the user terminal 30 via at least one of the reading unit or the input/output unit.

Moreover, it is only required for the game system 1 to include at least one computer, and is not limited to the example of FIG. 1. For example, the game system 1 may include the game server 10 and anther computer (for example, a server computer or a personal computer). Similarly, it is only required for the electronic commerce system 2 to include at least one computer, and is not limited to the example of FIG. 1. For example, the electronic commerce system 2 may include the electronic commerce server 20 and another computer (for example, a server computer or a personal computer).

### 2. Overview of at Least One Embodiment

In the at least one embodiment, a user account for the game and a user account for the electronic commerce have been issued to the user. The user has also finished link between the user account for the game and the user account for the electronic commerce to each other. For example, when the user specifies, from the browser of the user terminal 30, a URL of a game site being a website of the game, the user terminal 30 makes access to the game server 10. When login to the game site is successful, the user can play the game at the game site.

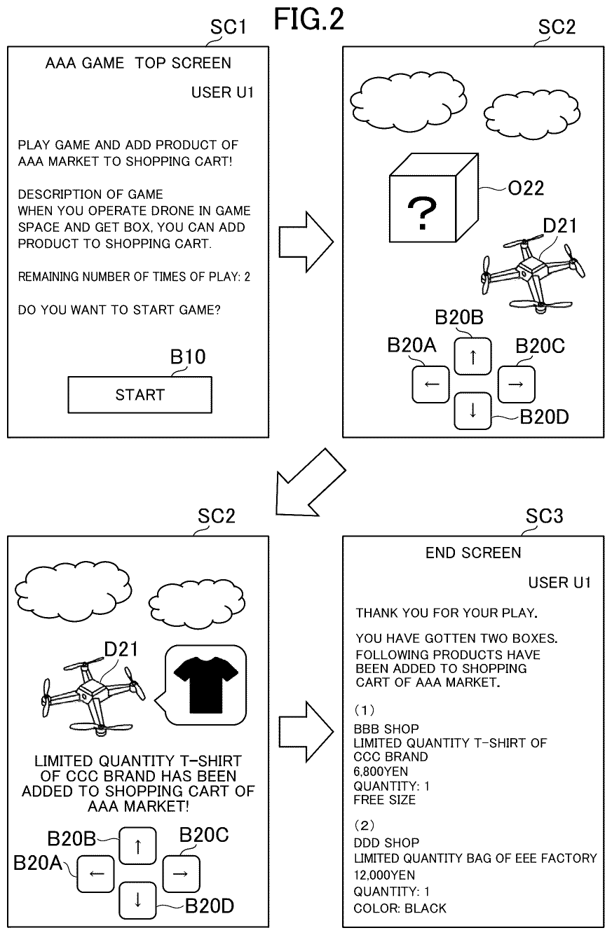

FIG. 2 is a view for illustrating an example of a scene in which the user plays the game. For example, when the user logs in to the game site, a top screen SC1 corresponding to a top page of the game site is displayed on the display unit 35. In the at least one embodiment, there is exemplified a game in which the user moves a drone in a game space, to thereby aim to acquire an object disposed in the game space, but the game may be of any kind, and is not limited to the example of the at least one embodiment. For example, the game may be a puzzle game, a quiz game, an action game, a shooting game, a role-playing game, or a game of another type.

For example, when the user selects a button B10, the game starts. When the game starts, a game screen SC2 indicating a scene of the game space is displayed on the display unit 35. The user operates the buttons B20A to B20D, to thereby move a drone D21 in the game space. In the game space, an object O22 indicating a box having unknown content is disposed. When the drone D21 touches the object O22 in the game space, the user can acquire the object O22.

In the at least one embodiment, a product sold in online shopping being an example of the electronic commerce is associated with the object O22. For example, when the user acquires the object O22, the game server 10 requests the electronic commerce server 20 to add this product to a shopping cart of the user. The electronic commerce server 20 adds this product to the shopping cart of the user based on the request from the game server 10.

For example, when the user acquires the object O22, as illustrated in the game screen SC2 on a lower left side of FIG. 2, the product associated with this object O22 is added to the shopping cart of the user. When a plurality of objects O22 are disposed in the game space, the user may successively acquire the plurality of objects O22. Each time the user acquires the object O22, the product is added to the shopping cart of the user.

In the example of FIG. 2, a specific product added to the shopping cart is unknown until the user acquires the object O22, but the product to be added to the cart may be known before the user acquires the object O22. For example, a texture indicating a product may be mapped on a surface of the object O22. Moreover, the object O22 may be any object, and is not limited to a box such as the one of FIG. 2. For example, the object O22 may be a three-dimensional model representing the product.

For example, when the drone D21 lands at a predetermined goal point, the game ends. A condition under which the game ends may be any condition, and is not limited to the example of the at least one embodiment. For example, the game may end under a condition that the user executes an operation for finishing the game, a condition that an elapsed time since the game started reaches a predetermined time, a condition that a predetermined number of objects O22 have been acquired, or another condition. When the game end, an end screen SC3 indicating that the game has ended is displayed on the display unit 35. On the end screen SC3, information on the products added to the shopping cart of the user is displayed.

For example, when the user specifies, from the browser of the user terminal 30, a URL of an electronic commerce site being a website of the electronic commerce, the user terminal 30 makes access to the electronic commerce server 20. When login to the electronic commerce site is successful, the user can check the content of his or her own shopping cart in the electronic commerce site. When the user logs in to the electronic commerce site after the game ends, the game and the electronic commerce may be linked to each other.

For example, when the user selects a link to the shopping cart in the electronic commerce site, a shopping cart screen indicating the content of the shopping cart is displayed on the display unit 35. The user may use, instead of the electronic commerce site, a program (for example, a so-called smartphone application) installed on the user terminal 30 and dedicated to electronic commerce to check the content of the shopping cart.

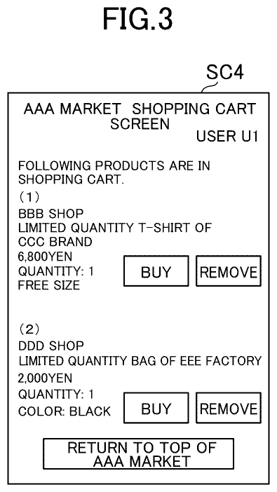

FIG. 3 is a view for illustrating an example of the shopping cart screen. As illustrated in FIG. 3, information on the product added to the shopping cart by the user acquiring the object O22 is displayed on a shopping cart screen SC4. The user can purchase the product in the shopping cart or remove the product in the shopping cart on the shopping cart screen SC4. A flow of the purchase and the removal of the product may be the same as the flow in a publicly-known electronic commerce site.

As described above, when the user has acquired the object O22 in the game, the game system 1 requests the electronic commerce system 2 to add the product associated with the object O22 to the shopping cart. The electronic commerce system 2 adds this product to the shopping cart of the user based on the request from the game system 1. As a result, the user not only simply shops, but also has the new experience of using the electronic commerce while enjoying the game as another pleasure. Thus, the game system 1 can increase entertainment (playability) of the user. Details of the at least one embodiment are now described.

### 3. Functions Implemented in at Least One Embodiment

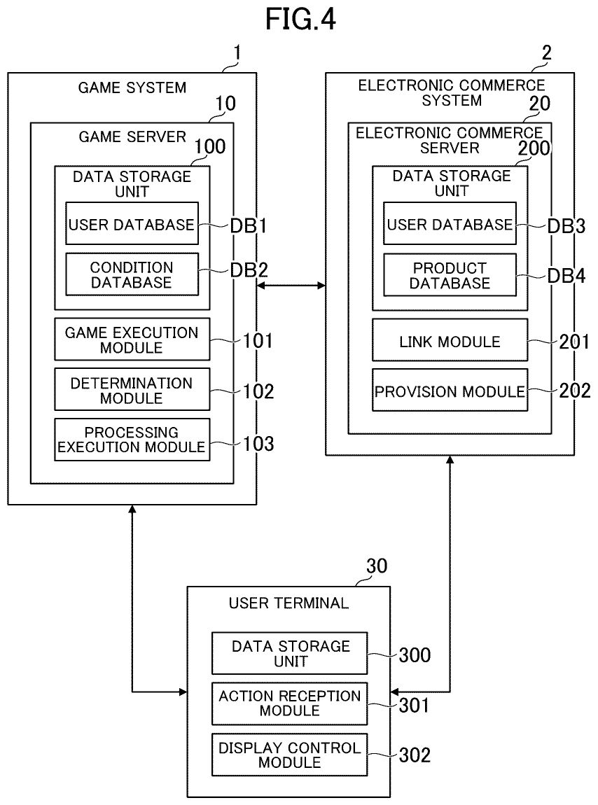

FIG. 4 is a diagram for illustrating an example of functions implemented in the at least one embodiment. Description is now given of functions which also assume electronic commerce other than the online shopping. For example, description is given of functions assuming not only a product traded in the electronic commerce, but also a service traded in the electronic commerce (for example, a reservation service provided in a reservation site for a facility such as a hotel, or a ticket for a transportation facility such as an airplane or an event).

### 3-1. Functions Implemented in Game System

For example, the game server 10 includes a data storage unit 100, a game execution module 101, a determination module 102, and a processing execution module 103. The data storage unit 100 is implemented by the storage unit 12. Each of the game execution module 101, the determination module 102, and the processing execution module 103 is implemented by the control unit 11.

### [Data Storage Unit]

The data storage unit 100 stores data required to provide the game to the user. For example, the data storage unit 100 stores a user database DB1 in the game and a condition database DB2.

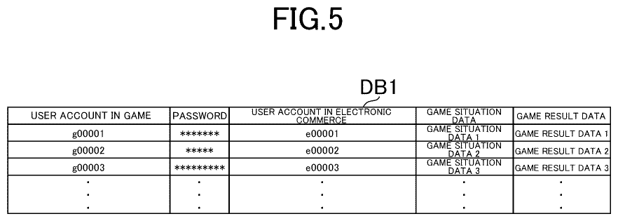

FIG. 5 is a table for showing an example of the user database DB1 in the game. The user database DB1 is a database in which various types of information on users having the user accounts in the game are stored. For example, in the user database DB1, the user accounts in the game, passwords to log in to the game site, the user accounts in the electronic commerce, game situation data, and game result data are stored. In the user database DB1, any information may be stored. The information stored in the user database DB1 is not limited to the example of FIG. 5. For example, in the user database DB1, personal information which the user has registered in the game site may be stored.

In the at least one embodiment, the user account in the game and the user account in the electronic commerce are linked to each other by storing those user accounts in the user database DB1. For example, the user links those user accounts to each other at the time of the registration to use the game or any timing thereafter. The user account in the game and the user account in the electronic commerce may be the same. That is, the user may be allowed to use both the game and the electronic commerce with one user account. In this case, the user account in the electronic commerce is not required to be stored in the user database DB1.

The game situation data is data indicating a situation of the game being executed. The game situation data may be data employed in a publicly-known game, and may include any information. For example, the game situation data indicates a current situation of the game space. In the game space, a virtual viewpoint (virtual camera) is set. On the game screen SC2, a scene of the game space viewed from the virtual viewpoint is displayed. The game space may be three-dimensional or two-dimensional.

When a game in augmented reality (AR) is executed, the game space may be a virtual space that is combined with a real space. For example, when the game in AR is executed, a video captured by a drone flying in the real space and an image indicating a scene in the virtual space may be combined with each other. Moreover, in addition to the game in AR, a game in virtual reality (VR) or a game in mixed reality (MR) may be executed. The game space is only required to be a space used in those games.

In the game in the example of FIG. 2, the game situation data includes information such as a position of the virtual viewpoint, a line-of-sight direction of the virtual viewpoint, a position of the drone D21, a direction of the drone D21, a movement direction of the drone D21, a position of the object O22, a direction of the object O22, information on the product associated with the object O22, information on the object O22 acquired by the user, information on the product added to the shopping cart of the user, and the elapsed time since the game start. When a game other than the game in the example of FIG. 2 is executed, the game situation data is only required to include information corresponding to the other game.

The game result data indicates a result of a game (game that has already ended) played by the user in the past. For example, the game result data includes a date and time of the play of the game by the user, the information on the object O22 acquired by the user, and the information on the product or the service associated with this object O22. In the game in the example of FIG. 2, the game result data includes the information on the object O22 touched by the drone D21 and the information on the product added to the shopping cart of the user. The game result data may include other information, and may include, for example, information on whether or not the user has purchased this product or other information.

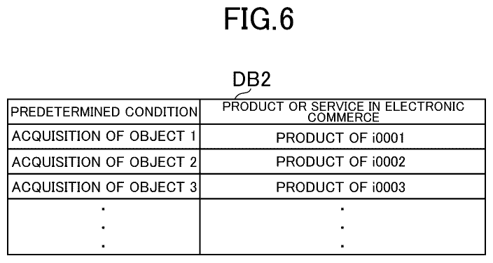

FIG. 6 is a table for showing an example of a condition database DB2. The condition database DB2 is a database indicating a relationship between each predetermined condition in the game and the product or the service in the electronic commerce. In the example of FIG. 6, the predetermined condition and the product or the service is in a one-to-one relationship, but the predetermined condition and the product or the service may be in a one-to-many, many-to-one, or many-to-many relationship. In the condition database DB2, any information may be stored. The information stored in the condition database DB2 is not limited to the example of FIG. 6. For example, in the condition database DB2, information that enables identifying the electronic commerce system 2 may be stored.

The predetermined condition is a condition corresponding to a trigger of processing by the processing execution module 103 described later. In the at least one embodiment, there is exemplified a case in which the acquisition of the object O22 by the user corresponds to the predetermined condition, but the predetermined condition is only required to be a condition which can be determined based on the user's actions in the game, and is not limited to the example of the at least one embodiment. For example, the predetermined condition may be acquisition, completion, or clearing of an item in the game through the user's actions in the game. The predetermined condition may be a condition which can be determined based on game situation data updated by the user's actions in the game.

For example, the predetermined condition may be a condition that the user achieves a score equal to or higher than a threshold value in the game, a condition that the user clears a mission in the game, a condition that the user clears the game, a condition that the user beats an enemy in the game, or a condition that the user helps a buddy in the game. The predetermined condition may be completion of a virtual object (for example, a picture of the product or a puzzle), answering correctly to a quiz relating to a virtual object (for example, a product), or another condition. The predetermined condition is only required to be a condition specified by the game provider, the electronic commerce provider, or another party.

In the example of FIG. 6, an example of the condition database DB2 in the case of the execution of the game of FIG. 2 is shown. For example, in the condition database DB2, object identification information that enables identifying the object O22 and product identification information that enables identifying the product to be added to the shopping cart when the user acquires this object O22 are stored. When the product has conditions such as a color and a size, this condition may also be stored in the condition database DB2 or this condition may be specified by the user himself or herself.

In the case of the electronic commerce which deals in not the product, but the service, not the product identification information, but service identification information that enables identifying the service is stored in the condition database DB2. For example, in the case of the electronic commerce which deals in the reservation service for a facility such as a hotel, facility identification information that enables identifying the facility is stored in the condition database DB2. In the case of the electronic commerce which deals in the reservation service for a travel product such as a tour, travel product identification information that enables identifying the travel product is stored in the condition database DB2. In the case of the electronic commerce which deals in the reservation service for a ticket for an event or the like, ticket identification information that enables identifying the ticket is stored in the condition database DB2. It is only required that information that enables identifying a certain product or service in the electronic commerce be associated with the predetermined condition.

In the at least one embodiment, it is assumed that the relationship between the predetermined condition and the product or the service is specified by the electronic commerce provider. The electronic commerce provider specifies this relationship, to thereby create data serving as a source of the condition database DB2. This data is transmitted to the game server 10 by the electronic commerce provider. The game server 10 stores this data in the condition database DB2. The relationship between the predetermined condition and the product or the service may be specified by the game provider, each member store which is open in the electronic commerce, or another party.

The data stored in the data storage unit 100 is not limited to the user database DB1 and the condition database DB2. The data storage unit 100 is only required to store certain data relating to the game. For example, the data storage unit 100 may store data required for the game such as a game program and data on the object O22 and data required to display screens in the game.

### [Game Execution Module]

The game execution module 101 executes the game based on the user's actions. The user's actions in the game are actions executed by the user during the execution of the game. In the at least one embodiment, there is exemplified a case in which the actions of the user selecting the buttons B20A to B20D corresponds to the user's actions in the game, but the user's actions in the game may be any actions, and is not limited to the example of the at least one embodiment. For example, the user's actions in the game may be actions for moving an object other than the drone D21 in the game space, selection of a certain command in the game, selection of a certain option in the game, or another actions. The user's actions in the game are not limited to the actions executed from the operation unit 34, but may be actions executed through sound or a gesture.

For example, when the user operates the user terminal 30 to access the game server 10, the game execution module 101 executes login processing for the user. The game execution module 101 determines whether or not a user account and a password input by the user and the user account and the password in the game stored in the user database DB1 match each other. When the game execution module 101 determines that the user accounts and the passwords do not match each other, the game execution module 101 determines that the login fails. When the game execution module 101 determines that the user accounts and the passwords match each other, the game execution module 101 determines that the login is successful. When the login is determined to be successful, the game execution module 101 displays the top screen SC1 of the game site on the user terminal 30.

For example, when the user selects the button B10 to start the game, the game execution module 101 disposes the object O22 in the game space based on the condition database DB2. The game execution module 101 may dispose, in the game space, all objects O22 set in the condition database DB2 as the predetermined conditions, or may dispose only some of the objects O22 in the game space. For example, the game execution module 101 may dispose, in the game space, some of the objects O22 randomly selected, or may dispose objects O22 with which products or services corresponding to preference of the user in the electronic commerce are associated. For example, in the electronic commerce, products or services which the user has shown intention to purchase or to use, such as ones associated with the user account via a candidate list such as a favorite list or the like, ones existing in a purchase history or a search history, and the like, are disposed in the game space in association with the objects O22. The position of the object O22 may be determined in advance, or may be determined based on a random number.

For example, the game execution module 101 disposes the drone D21 at an initial position determined in advance. The game execution module 101 generates the game situation data indicating the game space built as described above. The game execution module 101 stores the game situation data in the user database DB1. The game server 10 receives, from the user terminal 30, user's actions in the game data indicating the content of the user's actions in the game executed by the user. The game execution module 101 updates the game situation data based on the user's actions in the game indicated by the user's actions in the game data, to thereby execute the game. For example, the game execution module 101 updates the game situation data such that the drone D21 moves to a position corresponding to the user's actions in the game.

For example, when the determination module described later determines that the user has acquired the object O22, the game execution module 101 updates the game situation data such that the game situation data indicates that the user has acquired the object O22. The game execution module 101 is only required to update the game situation data by an update method corresponding to the content of the game. The update method for the game situation data may be a method employed in a publicly-known game. The game server 10 transmits the game situation data after the update to the user terminal 30. The user terminal 30 receives the game situation data from the game server 10.

The game situation data is updated through the communication between the game server 10 and the user terminal 30 executed subsequently until the game ends. When the game ends, the game execution module 101 generates game result data. The game execution module 101 stores the game result data in the user database DB1. The processing executed by the game execution module 101 is only required to be processing employed in a publicly-known game, and is not limited to the example of the at least one embodiment. The game execution module 101 is only required to update the game situation data based on the game program.

### [Determination Module]

The determination module 102 determines whether or not a predetermined condition associated with the product or the service in the electronic commerce is satisfied based on the user's actions in the game. The state in which the product or the service in the electronic commerce site and the predetermined condition are associated with each other is a state in which correspondence between the information that enables identifying the product or the service and information indicating the predetermined condition is defined. In the at least one embodiment, there is exemplified a case in which the correspondence is defined in the condition database DB2, but the correspondence may be defined in a database other than the condition database DB2, a table which is not considered as a database, data in a mathematical expression, a part of a program code, or other data.

In the at least one embodiment, the acquisition of the object O22 by the user corresponds to the predetermined condition, and hence the determination module 102 determines whether or not the user has acquired the object O22 in the game associated with the product or the service based on the user's actions in the game, to thereby determine whether or not the predetermined condition is satisfied. The determination module 102 determines whether or not the user has acquired the object O22 based on the game situation data updated in response to the user's actions in the game.

In the game in the example of FIG. 2, the determination module 102 executes collision determination between the drone D21 and the object O22. An algorithm of the collision determination may be a publicly-known algorithm. The determination module 102 determines that the user has not acquired the object O22 when it is determined that the drone D21 does not come in contact with the object O22 through the contact determination. The determination module 102 determines that the user has acquired the object O22 when it is determined that the drone D21 comes in contact with the object O22 through the contact determination.

The determination method of the determination module 102 is not limited to the above-mentioned example. The determination module 102 is only required to determine, based on a determination method defined in advance, whether or not the user has acquired the object O22. For example, when the user acquires the object O22 in the case in which the user clears a mission in the game, the determination module 102 determines whether or not the user has cleared the mission based on the game situation data. When the user is determined to have cleared the mission, the determination module 102 determines that the user has acquired the object O22. For example, in a case of a puzzle game, the determination module 102 may determine whether or not the user has completed the object O22, to thereby determine whether or not the user has acquired the object O22.

Moreover, when another condition other than the condition that the user acquires the object O22 is set, the determination module 102 is only required to determine whether or not the predetermined condition is satisfied by a determination method corresponding to this another condition. For example, the determination module 102 may determine whether or not the predetermined condition is satisfied by determining whether or not the user has cleared a mission irrelevant to the acquisition of the object O22. The determination module 102 may determine whether or not the predetermined condition is satisfied by determining whether or not a score in the game has become equal to or higher than a threshold value. The determination module 102 may determine whether or not the predetermined condition is satisfied by determining whether or not the user has beaten an enemy in the game.

### [Processing Execution Module]

When it is determined that the predetermined condition is satisfied, the processing execution module 103 executes processing for listing the product or the service associated with the predetermined condition with the candidate list of the user account of the user in the electronic commerce. The association of the product or the service with the candidate list of the user account in the electronic commerce corresponds to association of the information that enables identifying the product or the service with the candidate list of the user account in the electronic commerce. For example, addition of the product or the service to the candidate list of the user corresponds to the association of the product or the service with the candidate list of the user account in the electronic commerce.

The candidate list of the user account of the user is only required to be a list which associates the product and the service provided in the EC with the user account, and for example, a favorite list, a wish list, a like list, a my list, a buy-later list, and a watch list are examples thereof. Further, it is preferred that the candidate list of the user include a shopping cart (shopping basket) of the user. The shopping cart is always checked before payment as long as the user uses the EC, and hence the user reliably checks the product or the service which has been added to the shopping cart. Thus, it is possible to increase a chance of purchase.

In the at least one embodiment, when it is determined that the predetermined condition is satisfied, the processing execution module 103 executes processing for adding the product or the service associated with the predetermined condition to the shopping cart of the user account of the user. That is, the processing execution module 103 executes processing for adding the product identification information to the shopping cart identified by the user account in the electronic commerce. For example, the processing execution module 103 executes this processing by transmitting, to the electronic commerce server 20, the user account in the electronic commerce and the product identification information on the product (product associated with the predetermined condition) to be added to the shopping cart.

The processing executed by the processing execution module 103 is not limited to the example in the at least one embodiment. For example, the processing execution module 103 may execute the above-mentioned processing by not requesting the electronic commerce server 20 to add the product to the shopping cart, but adding the product to the shopping cart by the processing execution module 103 itself. The processing execution module 103 may execute the above-mentioned processing by executing purchase processing for the product without adding the product to the shopping cart. The processing execution module 103 may execute the above-mentioned processing by adding the product to the favorite list.

Moreover, for example, in the case of the electronic commerce of receiving the reservation for the facility such as a hotel, the processing execution module 103 may execute the above-mentioned processing by adding, to a list (an example of the candidate list) including candidates of the reservation, a facility associated with the predetermined condition or a predetermined service (service such as accommodation and meals) provided by the facility. Moreover, in the case of the electronic commerce of receiving the reservation for the transportation facility such as an airplane, the processing execution module 103 may execute the above-mentioned processing by adding, to a list including candidates of the reservation, a transportation facility associated with the predetermined condition or a predetermined service (service such as purchase or reservation of a ticket) provided by the transportation facility. For example, in the case of the electronic commerce of receiving the reservation for the ticket for an event or the like, the processing execution module 103 may execute the above-mentioned processing by adding, to a list including candidates of the reservation, the ticket for the event associated with the predetermined condition or a predetermined service (service such as priority admission and acquisition of premium) provided accompanying the event.

### 3-2. Functions Implemented in Electronic Commerce System

For example, the electronic commerce system 2 includes a data storage unit 200, a link module 201, and a provision module 202. The data storage unit 200 is mainly implemented by the storage unit 22. The link module 201 and the provision module 202 are mainly implemented by the control unit 21.

### [Data Storage Unit]

The data storage unit 200 stores data required to provide the electronic commerce to the user. For example, the data storage unit 200 stores a user database DB3 in the electronic commerce and a product database DB4.

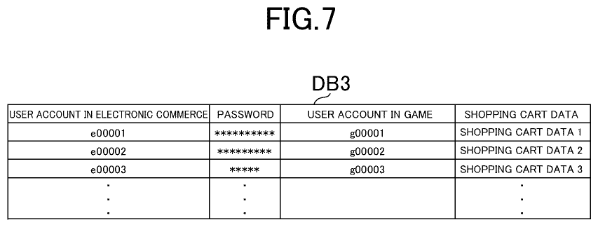

FIG. 7 is a table for showing an example of the user database DB3 in the electronic commerce. The electronic commerce database is a database which stores various types of information on users having user accounts in the electronic commerce. For example, in the electronic commerce database, the user accounts in the electronic commerce, the passwords for the login to the electronic commerce site, the user account in the game, and the shopping cart data are stored. In the electronic commerce database, any information may be stored. The information stored in the electronic commerce database is not limited to the example of FIG. 7. For example, in the electronic commerce database, data on the favorite lists of the users may be stored.

In the at least one embodiment, the user account in the game and the user account in the electronic commerce are linked to each other by storing those user accounts in the user database DB3. For example, the user links those user accounts to each other at the time of the registration to use the electronic commerce or any timing thereafter. The link of the user account may be executed in only one of the user database DB3 in the electronic commerce and the user database DB1 in the game.

The shopping cart data is data indicating the content of the shopping cart of the user. For example, the shopping cart data includes the product identification information on a product added to the shopping cart, the number of the products, information on a color, a size, or the like of the product, a unit price of the product, a coupon applied to the product, and other information. The shopping cart data is only required to be data having a format employed in publicly-known electronic commerce.

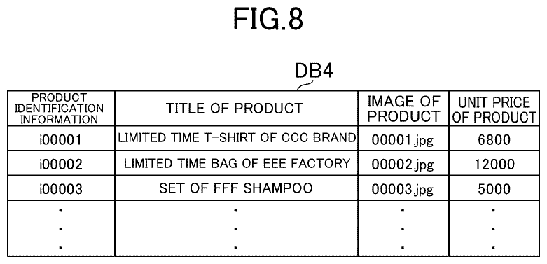

FIG. 8 is a table for showing an example of the product database DB4. The product database DB4 is a database in which various types of information on the products in the electronic commerce are stored. For example, in the product database DB4, the product identification information, titles of the products, images of the products, and the unit prices of the products are stored. In the product database DB4, any information may be stored. The information stored in the product database DB4 is not limited to the example of FIG. 8. For example, in the product database DB4, information on a member store which deals in the product, a description of the product, and information on stock of the product may be stored.

In the at least one embodiment, all or some of the pieces of product identification information stored in the product database DB4 are stored in the condition database DB2 stored in the game server 10. That is, the pieces of product identification information on all or some of the products which the user can purchase in the electronic commerce are stored in the condition database DB2, and are associated with the predetermined conditions. For example, the electronic commerce provider specifies the predetermined condition in the game and any of the products having the product identification information stored in the product database DB4, to thereby create data serving as a source of the condition database DB2. As described above, a party other than the electronic commerce provider may create this data.

The data stored in the data storage unit 200 is not limited to the user database DB3 and the product database DB4. The data storage unit 200 is only required to store certain data relating to the electronic commerce. For example, when not products, but services are provided in the electronic commerce, the data storage unit 200 may store a service database in which various types of information relating to the services in the electronic commerce are stored. The service database is different from the product database DB4 in the point that the information relating to the services is stored, but is the same as the product database DB4 in other points. Thus, in the service database, a portion described as product in the description of the product database DB4 is only required to be read as service. The data storage unit 200 may store other data such as data for displaying the electronic commerce site on the user terminal 30.

### [Link Module]

The link module 201 executes various types of processing relating to the link between the game and the electronic commerce. For example, when the request indicating the addition of the product to the shopping cart of the user is received from the game server 10, the link module 201 updates the user database DB3 such that the product is added to the shopping cart of the user. The link module 201 updates one of the pieces of shopping cart data stored in the user database DB3 that is associated with the user account which is in the electronic commerce and belongs to the user who has acquired the object O22.

For example, when the user account in the electronic commerce is included in the request from the game server 10, the link module 201 updates the shopping cart data associated with this user account. When the user account in the game is included in the request from the game server 10, the link module 201 refers to the user database DB3, to thereby identify the user account which is in the electronic commerce, and is associated with the user account in the game. The link module 201 updates the shopping cart data associated with the identified user account.

### [Provision Module]

The provision module 202 provides the electronic commerce to the user. For example, the provision module 202 displays the electronic commerce site on the user terminal 30. When the user executes an action of adding the product to the shopping cart in the electronic commerce site, the provision module 202 executes processing of adding the product to the shopping cart of the user. When the user executes an action of purchasing the product in the shopping cart in the electronic commerce site, the provision module 202 executes the payment for the product selected by the user. This series of processing steps may be the same as processing employed in publicly-known electronic commerce.

### 3-3. Functions Implemented in User Terminal

For example, the user terminal 30 includes a data storage unit 300, an action reception module 301, and a display control module 302. The data storage unit 300 is implemented mainly by the storage unit 32. The action reception module 301 and the display control module 302 are mainly implemented by the control unit 31.

### [Data Storage Unit]

The data storage unit 300 stores data required for the user to use each of the game and the electronic commerce. For example, the data storage unit 300 stores a browser or a dedicated program (for example, so-called smartphone application) for displaying a screen of each of the game site and the electronic commerce site.

### [Action Reception Module]

The action reception module 301 receives various actions of the user. For example, the action reception module 301 receives the user's actions in the game of the user. The action reception module 301 transmits, to the game server 10, the user's actions in the game data indicating the user's actions in the game executed by the user. When the user executes a certain action in the electronic commerce site, the action reception module 301 transmits data indicating this action to the electronic commerce server 20.

### [Display Control Module]

The display control module 302 displays various screens on the display unit 35. For example, the display control module 302 displays the top screen SC1, the game screen SC2, the end screen SC3, and the shopping cart screen SC4 on the display unit 35.

### 4. Processing Executed in at Least One Embodiment

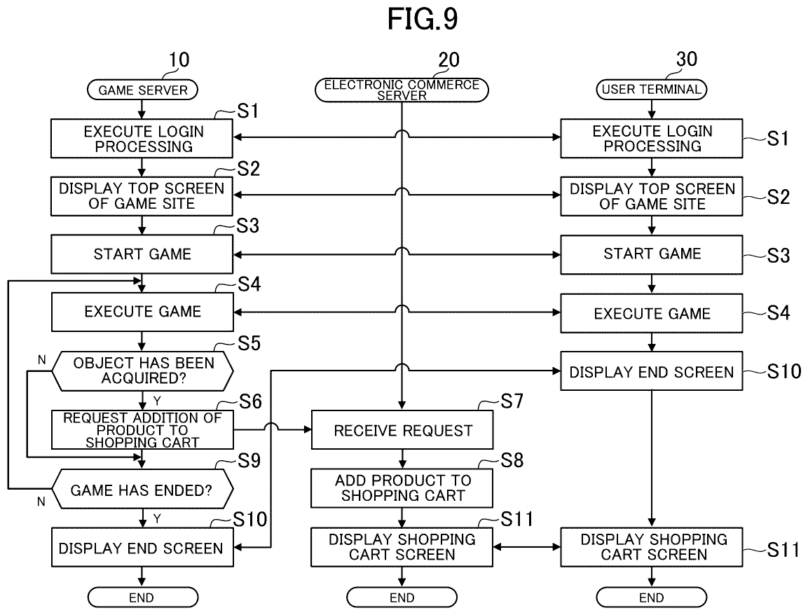

FIG. 9 is a diagram for illustrating an example of processing executed in the game system 1 and the like. The processing of FIG. 9 is executed by the control units 11, 21, and 31 executing programs stored in the storage units 12, 22, and 32, respectively. It is assumed that the user has linked the user account in the game and the user account in the electronic commerce to each other before the execution of the processing of FIG. 9.

As illustrated in FIG. 9, when the user selects the URL of the game site, the user terminal 30 executes, between the user terminal 30 and the game server 10, the login processing for the user to log in to the game site (Step S1). When the login to the game site is successful, the processing for displaying the top screen SC1 of the game site on the display unit 35 is executed between the game server 10 and the user terminal 30 (Step S2). When the user selects the button B10, the processing for starting the game is executed between the game server 10 and the user terminal 30 (Step S3).

The processing for executing the game is executed based on the user's actions in the game of the user between the game server 10 and the user terminal 30 (Step S4). The game server 10 determines whether or not the user has acquired the object O22 (Step S5). When it is not determined that the user has acquired the object O22 (N in Step S5), the process proceeds to Step S9 described later. When it is determined that the user has acquired the object O22 (Y in Step S5), the game server 10 requests the electronic commerce server 20 to add the product to the shopping cart (Step S6). The request transmitted in Step S6 includes the user account in the electronic commerce and the product identification information (product identification information associated with the object O22 acquired by the user) on the product to be added to the shopping cart.

The request transmitted in Step S6 may include, in addition to the user account in the game, for example, only a result of the game such as the acquisition of the object O22 or the like. In this case, on the electronic commerce server 20 side, the product identification information associated with the object O22 is identified based on the user account in the game and the result of the game, and is associated with the user account in the electronic commerce. Moreover, in place of the user account, other information that enables identifying the user may be transmitted. Further, the game server 10 and the electronic commerce server 20 may execute the transmission and reception via still another server therebetween. This point applies to modification examples of the present disclosure described later.

When the request is received from the game server 10 (Step S7), the electronic commerce server 20 adds the product to the shopping cart (Step S8). In Step S8, the electronic commerce server 20 acquires the user account in the electronic commerce included in the request received from the game server 10. The electronic commerce server 20 adds the product identification information included in the request received from the game server 10 to one of the pieces of shopping cart data stored in the user database DB3 in the electronic commerce that is associated with the acquired user account.

The game server 10 determines whether or not the game has ended (Step S9). When it is not determined that the game has ended (N in Step S9), the process returns to Step S4. When it is determined that the game has ended (Y in Step S9), the processing for displaying the end screen SC3 is executed between the game server 10 and the user terminal 30 (Step S10). When the user executes the action for checking the content of the cart of the electronic commerce site, the processing for displaying the shopping cart screen SC4 is executed between the electronic commerce server 20 and the user terminal 30 (Step S11), and this processing is finished. Details of this series of processing steps are as described above.

### 5. Summary of at Least One Embodiment

The game system 1 of the at least one embodiment executes the game based on the user's actions in the game of the user. The game system 1 determines whether or not the predetermined condition associated with the product or the service in the electronic commerce is satisfied based on the user's actions in the game. When it is determined that the predetermined condition is satisfied, the game system 1 executes the processing for listing the product or the service associated with the predetermined condition with the candidate list of the user account of the user in the electronic commerce. As a result, the user not only simply shops, but also has the new experience of using the electronic commerce while enjoying the game as another pleasure. Thus, the game system 1 can increase the entertainment of the user.

Moreover, the game system 1 determines whether or not the user has acquired the object O22 in the game associated with the product or the service based on the user's actions in the game, to thereby determine whether or not the predetermined condition is satisfied. As a result, the user can have the new experience through the action having high entertainment such as the acquisition of the object O22, and hence the game system 1 can further increase the entertainment of the user.

Moreover, when it is determined that the predetermined condition is satisfied, the game system 1 executes the processing for adding the product or the service associated with the predetermined condition to the shopping cart of the user account of the user. As a result, the user reliably checks the product or the service through the addition of the product or the service to the shopping cart, and hence the game system 1 can further increase the chance of purchase by the user.

### 6. Modification Examples

The present disclosure is not limited to the above-mentioned at least one embodiment. The present disclosure may appropriately be modified without departing from the purport of the present disclosure.

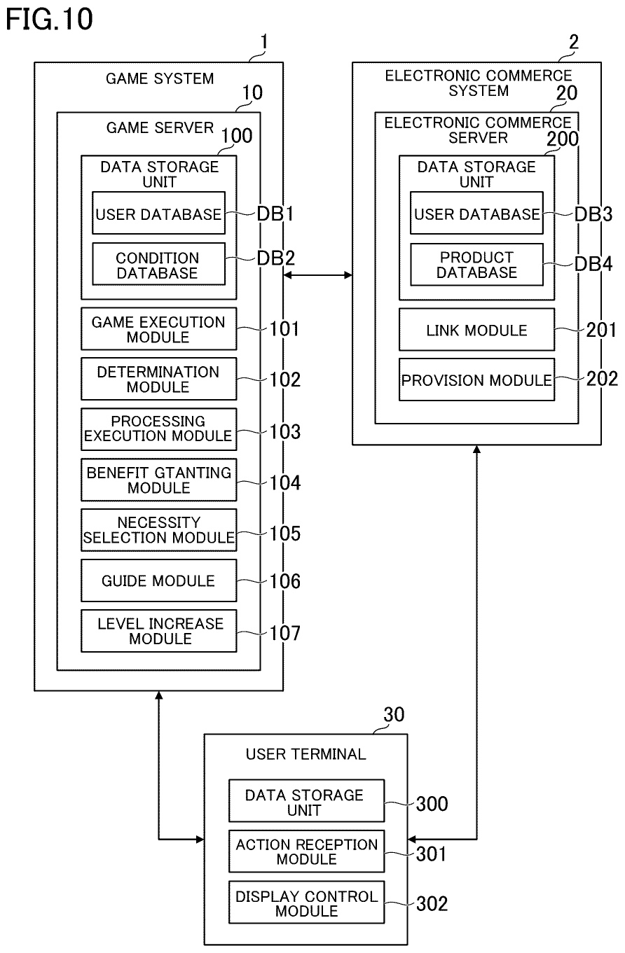

FIG. 10 is a diagram for illustrating an example of functions implemented in the modification examples. As illustrated in FIG. 10, the game server 10 in the modification examples includes a benefit granting module 104, a necessity selection module 105, a guide module 106, and a level increase module 107. Each of the benefit granting module 104, the necessity selection module 105, the guide module 106, and the level increase module 107 is implemented by the control unit 11.

### 6-1. Modification Example 1

For example, in the at least one embodiment, there has been exemplified the case in which it is determined whether or not the predetermined condition is satisfied based on the user's actions in the game of the user. The processing executed based on the user's actions in the game is not limited to the example in the at least one embodiment. For example, a certain benefit relating to the product or the service in the electronic commerce may be given to the user based on the user's actions in the game.

The game system 1 of Modification Example 1 includes the benefit granting module 104. The benefit granting module 104 grants a benefit relating to the product or the service to the user based on the user's actions in the game. The benefit is a certain profit or a benefit which occurs in the user. In Modification Example 1, there is exemplified a case in which a coupon for the product or the service associated with the predetermined condition corresponds to the benefit, but the benefit granting module 104 may grant any benefit. The benefit granted to the user by the benefit granting module 104 is not limited to the example of Modification Example 1. For example, at least one of a discount without a coupon, an increase in points acquired by the user in the electronic commerce, free shipping, a certain fee being free, a free product or service granted to the user, or an increase in quantity of the product or the service may correspond to the benefit.

The benefit granting module 104 determines whether or not a condition for granting the benefit to the user is satisfied based on the user's actions in the game. In Modification Example 1, there is exemplified a case in which this condition and the predetermined condition described in the at least one embodiment are different from each other, but this condition and the predetermined condition described in the at least one embodiment may be the same. This condition may be defined in the code of the game program or may be defined in setting data referred to by the game program. As an example of the condition for granting the benefit, there is described a case of acquisition of another object different from the object O22 relating to the addition of the product to the shopping cart.

When the condition for granting the benefit to the user by the benefit granting module 104 and the predetermined condition described in the at least one embodiment are the same, the benefit granting module 104 may add a product to the shopping cart when the user has acquired the object O22, and may grant a benefit available for this product. Moreover, for example, the benefit granting module 104 may add a product to the shopping cart when the user has acquired the object O22, and may grant the benefit to the user when the drone thereafter completes travel along a specified route or when the user has acquired a predetermined number of objects O22.

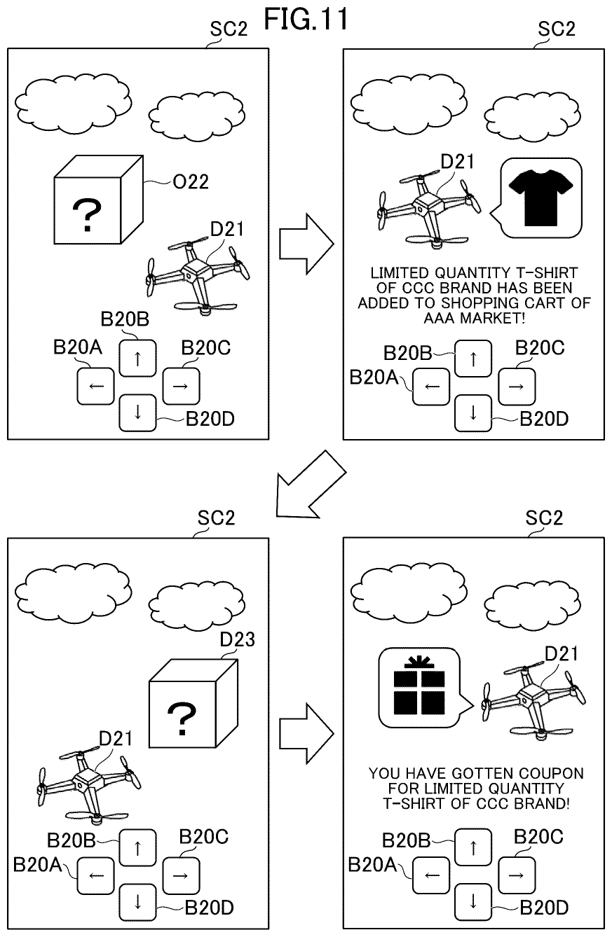

FIG. 11 is a view for illustrating an example a game executed in Modification Example 1. The flow until the user acquires the object O22 (upper left and upper right game screens SC2 of FIG. 11) is the same as that in the at least one embodiment. As illustrated in a lower left game screen SC2 of FIG. 11, another object O23 for the benefit granting module 104 to grant the benefit to the user is disposed in the game space. For example, the benefit granting module 104 determines, based on the user's actions in the game, whether or not the user has acquired the another object O23. This determination method may be the same as the determination method of determining whether or not the user has acquired the object O22.

For example, the benefit granting module 104 does not grant the benefit to the user when it is not determined that the user has acquired the another object O23. The benefit granting module 104 grants the benefit to the user when it is determined that the user has acquired the another object O23. As illustrated in a lower right game screen SC2 of FIG. 11, the benefit granting module 104 grants the benefit to the user during the execution of the game. The benefit granting module 104 may grant the benefit to the user after the end of the game.

For example, when a coupon corresponds to the benefit, the benefit granting module 104 requests the electronic commerce server 20 to grant the coupon to the user. This request includes the user account in the electronic commerce and a coupon code that enables identifying the coupon. When the request is received, the electronic commerce server 20 grants the coupon to the user based on the user account in the electronic commerce and the coupon code that enables identifying the coupon. The user can use this coupon in the electronic commerce. A granting method itself for the coupon may be the same as a method employed in publicly-known electronic commerce.

When another benefit other than the coupon is to be granted to the user, the benefit granting module 104 is only required to execute processing corresponding to this another benefit. For example, when the discount without a coupon corresponds to the benefit, the benefit granting module 104 requests the electronic commerce server 20 to apply the discount of the product or the service. When the request is received, the electronic commerce server 20 applies the discount of the product or the service. An application method itself for the discount may be the same as a method employed in publicly-known electronic commerce. The same applies to other benefits, and the granting method itself for the benefit may be the same as a method employed in publicly-known electronic commerce.

The game system 1 of Modification Example 1 grants a benefit relating to the product or the service to the user based on the user's actions in the game. The game system 1 can further increase the entertainment of the user. For example, it is possible to provide, to the user, the enjoyment of finding the another object O23 for acquiring the coupon for the product inside the game space, and hence it is possible to motivate the user to play the game. For example, the game system 1 can plan to acquire new customers and to extend sales in the electronic commerce.

### 6-2. Modification Example 2

For example, in the at least one embodiment, there has been exemplified the case in which when the user has acquired the object O22, a product associated with this object O22 is automatically added to the shopping cart. This product may be unnecessary for the user. Thus, in Modification Example 2, when the user has acquired the object O22, the user may be allowed to select whether or not the product associated with this object O22 is to be added to the shopping cart.

The game system 1 of Modification Example 2 includes the necessity selection module 105. When it is determined that the predetermined condition is satisfied, the necessity selection module 105 allows the user to select, in the game, whether or not the association between the user account in the electronic commerce and the product or the service is necessary. Whether or not the association is necessary corresponds to whether or not the processing execution module 103 is caused to execute the processing for this association. For example, the necessity selection module 105 displays an image for the user to select the necessity of the association in the game. This image includes a first image indicating that the association is necessary and a second image indicating that the association is not necessary.

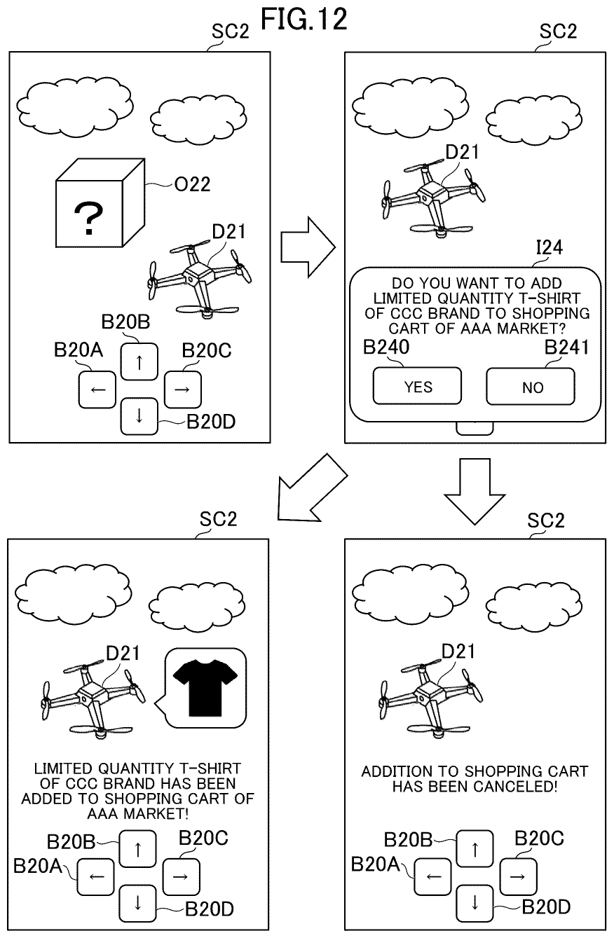

FIG. 12 is a view for illustrating an example of a game executed in Modification Example 2. For example, when the user has acquired an object O22 under a state of an upper left game screen SC2 of FIG. 12, as illustrated in an upper right game screen SC2 of FIG. 12, the necessity selection module 105 displays an image 124 asking whether or not a product associated with this object O22 is to be added to the shopping cart on the game screen SC2. The image 124 includes a button B240 (an example of the above-mentioned first image) indicating that the product is to be added to the shopping cart and a button B241 (an example of the above-mentioned second image) indicating that the product is not to be added to the shopping cart. The user selects any one of the button B240 or the button B241.

The necessity selection module 105 may display an image different from the image 124 on the user terminal 30, to thereby allow the user to select the necessity of the association. Moreover, for example, the necessity selection module 105 does not display the image for receiving the action of the user on the game screen SC2, but may display a message instructing a predetermined action from the operation unit 34 (for example, a message “if you wants to add the product to the shopping cart, press button oo of the operation unit 34”) on the game screen SC2, to thereby allow the user to select the necessity of the association.

When it is determined that the predetermined condition is satisfied, the processing execution module 103 in Modification Example 2 executes the processing described in the at least one embodiment based on a selection result of the necessity made in the game. For example, when the user has selected the button B240, the processing execution module 103 executes the processing described in the at least one embodiment as illustrated in a lower left game screen SC2 of FIG. 12, to thereby add the product to the shopping cart. When the user has selected the button B241, the processing execution module 103 does not execute the processing described in the at least one embodiment as illustrated in a lower right game screen SC2 of FIG. 12, and hence does not add the product to the shopping cart. When the user selects the necessity through another action, the processing execution module 103 may determine whether or not the product is to be added to the shopping cart based on this another action.

When it is determined that the predetermined condition is satisfied, the game system 1 of Modification Example 2 allows the user to select, in the game, whether or not the association between the user account and the product or the service is necessary. When it is determined that the predetermined condition is satisfied, the game system 1 executes the processing described in the at least one embodiment based on a selection result of the necessity made in the game. The game system 1 can allow the user to select the necessity of the processing described in the at least one embodiment, and hence convenience for the user increases. For example, when an unnecessary product is added to the shopping cart, labor of the user to delete the product from the shopping cart occurs. However, the occurrence of the labor can be prevented by allowing the user to select the necessity in the game. When the user cannot know a specific product to be added to the shopping cart until the user acquires the object O22 as in the at least one embodiment, the convenience for the user particularly increases.

### 6-3. Modification Example 3

For example, in Modification Example 2, there has been exemplified the case in which the user is allowed to select the necessity in the game. When it is determined that the predetermined condition is satisfied, the necessity selection module 105 may allow the user to select, after the end of the game, whether or not the association between the user account and the product or the service is necessary. The necessity selection module 105 may allow the user to select a plurality of pieces of necessity at once after the end of the game.

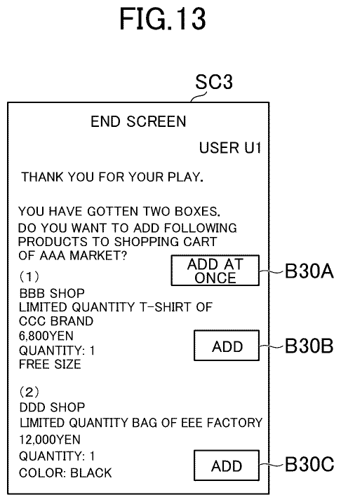

FIG. 13 is a view for illustrating an example of the end screen SC3 in Modification Example 3. As illustrated in FIG. 13, when the game ends after the user has acquired a plurality of objects O22, the necessity selection module 105 displays, on the user terminal 30, the end screen SC3 including buttons B30A to B30C each indicating whether or not a corresponding product is to be added to the shopping cart. For example, when the user selects the button B30A, the user can add all products at once to the shopping cart. When the user selects the button B30B, the user can add a first product to the shopping cart. When the user selects the button B30C, the user can add a second product to the shopping cart.

When it is determined that the predetermined condition is satisfied, the processing execution module 103 in Modification Example 2 executes the processing described in the at least one embodiment based on a selection result of the necessity made after the end of the game. Modification Example 2 is different from Modification Example 1 in such a point that the necessity is selected after the end of the game, but is the same as Modification Example 1 in such a point that the processing execution module 103 executes the processing described in the at least one embodiment based on the necessity selected by the user. The processing execution module 103 requests the electronic commerce server 20 to add the product selected by the user as the product the association of which is necessary to the shopping cart.

When it is determined that the predetermined condition is satisfied, the game system 1 of Modification Example 3 allows the user to select, after the end of the game, whether or not the association between the user account and the product or the service is necessary. When it is determined that the predetermined condition is satisfied, the game system 1 executes the processing described in the at least one embodiment based on the selection result of the necessity made after the end of the game. The game system 1 can allow the user to select the necessity of the processing described in the at least one embodiment, and hence the convenience for the user increases. Further, it is possible to prevent a flow of the game from stopping in the course by allowing the user to select the necessity after the end of the game, and hence entertainment of the user can further be increased.

### 6-4. Modification Example 4

For example, the user may be guided to the shopping cart screen SC4 after the user finishes the game. The game system 1 of Modification Example 4 includes the guide module 106. The guide module 106 guides, after the end of the game, the user to a screen for the electronic commerce (for example, the shopping cart screen SC4) relating to the product or the service associated with the user account through the processing by the processing execution module 103. In Modification Example 4, there is exemplified a case in which the guide module 106 provides the guidance on the end screen SC3, but the guide module 106 may provide the guidance on a screen other than the end screen SC3.

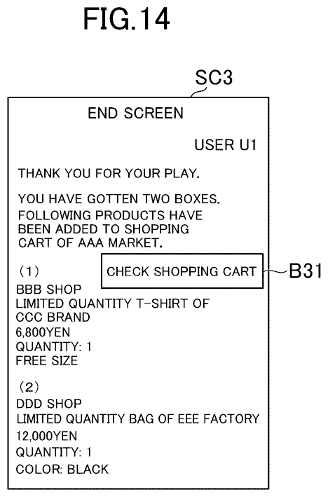

FIG. 14 is a view for illustrating an example of the end screen SC3 in Modification Example 3. The guide module 106 displays the end screen SC3 including a button B31 indicating a link to the shopping cart screen SC4 on the user terminal 30, to thereby guide the user to the screen for the electronic commerce. The guide module 106 may display a similar image indicating the link on a screen other than the end screen SC3. When the user selects the button B31, the user terminal 30 displays the shopping cart screen SC4 on the display unit 35. Processing for displaying the shopping cart screen SC4 may be the same as that in the at least one embodiment. The link indicated by the button B31 may not be the link to the shopping cart screen SC4, but a link to a product page for the product added to the shopping cart.

The game system 1 of Modification Example 4 guides, after the end of the game, the user to the screen for the electronic commerce relating to the product or the service associated with the user account. The game system 1 can allow the user to directly access the screen for the electronic commerce after the end of the game, and hence can increase the convenience for the user.

### 6-5. Modification Example 5

For example, when the user has purchased the product added to the shopping cart as a result of the acquisition of the object O22, a level increase of the game may be executed. The level increase means an increase in level of the game. Specifically, for example, the level increase may be only required to be a publicly-known one such as an increase in degree of difficulty of the game, opening of a new stage or the like, an increase in strength of a game character, or granting of a new game item or game reward to the user. In the user database DB1, the level of the user is stored. The game system 1 of Modification Example 5 includes the level increase module 107. The level increase module 107 increases the level of the game when the user has conducted a commerce activity relating to the product or the service associated with the user account through the processing by the processing execution module 103. For example, as the level of the game increases, the degree of difficulty of the game may increase, but the benefit described in Modification Example 1 may be made better.

For example, when the user purchases a product added to the shopping cart, the electronic commerce server 20 transmits, to the game server 10, a notification indicating that the user has purchased the product. The game server 10 can identify the purchase of this product by the user based on the reception of this notification. The level increase module 107 increases the level of the user stored in the user database DB1. In Modification Example 5, the user can play the game corresponding to his or her own level. The data storage unit 100 stores a game program at each level. The game execution module 101 executes the game based on the game program or a game setting corresponding to the level of the user. The method of increasing the level of the game may be a method employed in a publicly-known game.

The game system 1 of Modification Example 5 increases the level of the game when the user has conducted the commerce activity relating to the product or the service associated with the user account. The game system 1 reflects the presence or absence of the actual commerce activity by the user in the level of the game, thereby being able to further increase the entertainment of the user. For example, it is possible to motivate the user to purchase the product or to use the service by providing the bidirectionality between the execution of the game and the purchase of the product or the use of the service, and hence further sales expansion can be achieved.

### 6-6. Modification Example 6

For example, the game system 1 may link to a plurality of electronic commerce systems 2. In Modification Example 6, there are exemplified three electronic commerce systems being an electronic commerce system 2 for the online shopping, an electronic commerce system 2 (hereinafter referred to as “electronic commerce system 2 for the facility reservation”) for receiving the reservation for the facility such as a hotel, and an electronic commerce system 2 (hereinafter referred to as “electronic commerce system 2 for the ticket reservation”) for receiving the reservation for the ticket for an event or the like. The number of the electronic commerce systems 2 to which the game system 1 links is not limited to three, and may be two or four or more.

Processing for the link between the game system 1 and each electronic commerce systems 2 may be the same as that in the at least one embodiment and Modification Example 1 to Modification Example 5. In Modification Example 6, it is assumed that a predetermined condition for each of the plurality of electronic commerce systems 2 is set in one game. In the example of the game of FIG. 2, it is assumed that the object O22 for the electronic commerce system 2 for the online shopping, the object O22 for the electronic commerce system 2 for the facility reservation, and the object O22 for the electronic commerce system 2 for the ticket reservation are disposed in the game space.

The determination module 102 in Modification Example 6 determines whether or not a predetermined condition for each of the plurality of electronic commerce systems 2 is satisfied based on the user's actions in the game. For example, the determination module 102 determines whether or not each of the object O22 for the electronic commerce system 2 for the online shopping, the object O22 for the electronic commerce system 2 for the facility reservation, and the object O22 for the electronic commerce system 2 for the ticket reservation is acquired by the user. A determination method for the acquisition of each object O22 may be the same as that in the at least one embodiment.

The processing execution module 103 in Modification Example 6 executes the processing of one of the plurality of electronic commerce systems 2 for which the predetermined condition is determined to be satisfied. For example, when the user is determined to have acquired the object O22 for the electronic commerce system 2 for the online shopping, the processing execution module 103 executes the processing of adding a product associated with this object O22 to the shopping cart of the electronic commerce system 2 for the online shopping.

For example, when the user is determined to have acquired the object O22 for the electronic commerce system 2 for the facility reservation, the processing execution module 103 executes the processing of adding a facility associated with this object O22 to the candidate list of the electronic commerce system 2 for the facility reservation. When the user is determined to have acquired the object O22 for the electronic commerce system 2 for the ticket reservation, the processing execution module 103 executes the processing of adding a ticket associated with this object O22 to the candidate list of the electronic commerce system 2 for the ticket reservation.

The game system 1 of Modification Example 6 determines whether or not a predetermined condition for each of the plurality of electronic commerce systems 2 is satisfied based on the user's actions in the game. The game system 1 executes the processing of one of the plurality of electronic commerce systems 2 for which the predetermined condition is determined to be satisfied. The game system 1 links to the plurality of electronic commerce system 2, thereby being able to further increase the entertainment of the user. The game system 1 can achieve sales promotion in a larger number of pieces of electronic commerce.

### 6-7. Modification Example 7

For example, in Modification Example 6, the game execution module 101 may display information that enables identifying one of the plurality of electronic commerce systems 2 that is associated with the predetermined condition in the game. This information is only required to be information visually recognizable by the user. In Modification Example 7, the game execution module 101 uses a color of the object O22 so that the electronic commerce system 2 corresponding to this object O22 is identifiable.

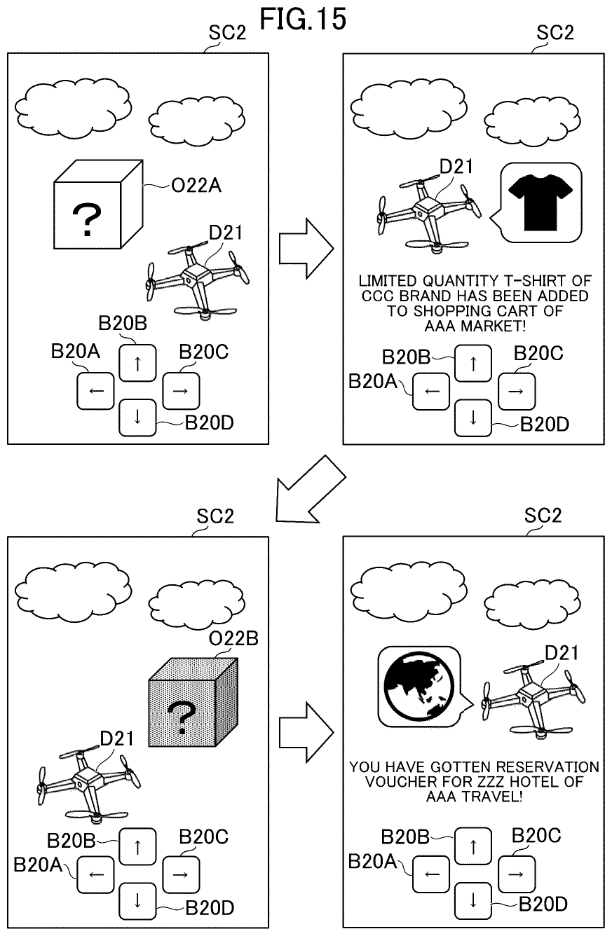

FIG. 15 is a view for illustrating an example of the game screen SC2 in Modification Example 7. For example, as illustrated in an upper left game screen SC2 of FIG. 15, the game execution module 101 displays an object O22A associated with a product of the electronic commerce system 2 for the online shopping on the game screen SC2 in a first color. As illustrated in a lower left game screen SC2 of FIG. 15, the game execution module 101 displays an object O22B associated with a service of the electronic commerce system 2 for the facility reservation on the game screen SC2 in a second color.

The game execution module 101 may make the electronic commerce system 2 identifiable through use of information other than the color of the object O22. For example, the game execution module 101 may make the electronic commerce system 2 identifiable through use of a size, a shape, a texture of a surface, or an effect of the object O22. The game execution module 101 may make the electronic commerce system 2 identifiable through use of not the appearance of the object O22, but display of a mark or a message indicating the electronic commerce system 2 on the game screen SC2.

The game system 1 of Modification Example 7 displays the information that enables identifying one of the plurality of electronic commerce systems 2 that is associated with the predetermined condition in the game. The game system 1 makes the relationship between the predetermined condition and the electronic commerce system 2 clearer in the game, thereby being able to further increase the convenience for the user.

### 6-8. Modification Example 8

For example, in Modification Example 6 and Modification Example 7, the case in which the plurality of electronic commerce systems 2 simultaneously exist in one game has been exemplified, but a game or a game part may be prepared for each electronic commerce system 2. The game part is a part of one game. For example, when a plurality of routes are defined in one certain game, each route corresponds to the game part. When a plurality of stories are defined in one certain game, each story corresponds to the game part. Moreover, for example, in a case of a game in which a plurality of stages exist, each stage corresponds to the game part.

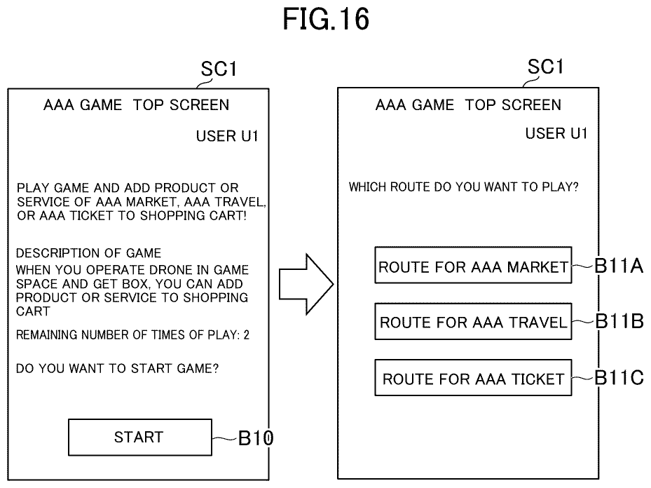

FIG. 16 is a view for illustrating an example a game executed in Modification Example 8. For example, the game execution module 101 executes a game or a game part selected by the user from among the games or game parts of each of the plurality of electronic commerce systems 2. In the example of FIG. 16, a plurality of routes (example of the game parts) are defined in one certain game. The user selects any one of a button B11A to a button B11C, to thereby select any one of the plurality of routes. The game execution module 101 disposes, in the game space, an object O22 of the electronic commerce system 2 corresponding to the route selected by the user.

For example, when the user selects the button B11A to select a route of the electronic commerce system 2 for the online shopping, the game execution module 101 disposes an object O22 of the electronic commerce system 2 for the online shopping in the game space. In this case, an object O22 of the electronic commerce system 2 for the facility reservation and an object O22 of the electronic commerce system 2 for the ticket reservation are not disposed in the game space.

For example, when the user selects the button B11B to select a route of the electronic commerce system 2 for the facility reservation, the game execution module 101 disposes an object O22 of the electronic commerce system 2 for the facility reservation in the game space. In this case, an object O22 of the electronic commerce system 2 for the online shopping and an object O22 of the electronic commerce system 2 for the ticket reservation are not disposed in the game space.

For example, when the user selects the button B11C to select a route of the electronic commerce system 2 for the ticket reservation, the game execution module 101 disposes an object O22 of the electronic commerce system 2 for the ticket reservation in the game space. In this case, an object O22 of the electronic commerce system 2 for the online shopping and an object O22 of the electronic commerce system 2 for the facility reservation are not disposed in the game space.

The user may select not the game part, but the game. For example, when the user has selected a game (for example, a puzzle game of completing a puzzle of a product) of the electronic commerce system 2 for the online shopping, the game execution module 101 executes this game. When the user has selected a game (for example, a quiz game relating to a hotel) of the electronic commerce system 2 for the facility reservation, the game execution module 101 executes this game. When the user has selected a game (for example, an action game having a stage set to an event site) of the electronic commerce system 2 for the ticket reservation, the game execution module 101 executes this game.

The determination module 102 in Modification Example 8 determines whether or not the predetermined condition of the game or the game part selected by the user is satisfied based on the user's actions in the game in the game or the game part selected by the user. In Modification Example 8, it is assumed that the predetermined condition is defined in each game or game part. Modification Example 8 is different from the at least one embodiment in such a point that the game or the game part selected by the user is the target, but is the same as the at least one embodiment in the determination method itself of the determination module 102.

The processing execution module 103 in Modification Example 8 executes the processing of one of the plurality of electronic commerce systems 2 that corresponds to the game or the game part selected by the user. Modification Example 8 is different from the at least one embodiment in the point that the game or the game part selected by the user is the target, but is the same as the at least one embodiment or Modification Example 7 in the processing itself executed by the processing execution module 103.

The game system 1 of Modification Example 8 executes the game or the game part selected by the user from among the games or the game parts of each of the plurality of electronic commerce systems 2. The game system 1 determines whether or not the predetermined condition of the game or the game part selected by the user is satisfied based on the user's actions in the game in the game or the game part selected by the user. The game system 1 executes the processing of one of the plurality of electronic commerce systems 2 that corresponds to the game or the game part selected by the user. The game system 1 links to the plurality of electronic commerce system 2, to thereby being able to further increase the entertainment of the user. Further, the game system 1 associates the game or the game part and the electronic commerce system 2 with each other. Thus, the relationship therebetween becomes clearer, and hence the convenience for the user can further be increased.

### 6-9. Other Modification Examples

For example, the above-mentioned modification examples may be combined with one another.

For example, in the at least one embodiment, there has been described the case in which the main processing is executed in the game server 10, but the processing described as the processing executed in the game server 10 may be executed in the electronic commerce server 20. In this case, the game system 1 may not exist, and the electronic commerce system 2 may correspond to the system according to the present disclosure. The electronic commerce system 2 has both the function of the game and the function of the electronic commerce. The system according to the present disclosure may be a system other than the game system 1 and the electronic commerce system 2. The processing described as the processing executed by the game server 10 may be executed in the user terminal 30 or another computer, or may be distributed to a plurality of computers.

### 7. Supplementary Notes

For example, the system may have the following configurations.

(1)

A system, including:
a game execution module configured to execute a game based on user's actions;
a determination module configured to determine whether a predetermined condition associated with one of a product or a service in electronic commerce is satisfied based on the user's actions in the game; and
a processing execution module configured to execute processing for listing one of the product or the service with a candidate list of a user account of the user in the electronic commerce when the predetermined condition is determined to be satisfied.

(2)

The system according to Item (1), wherein the determination module is configured to determine, based on the user's actions in the game, whether the user has acquired an object in the game associated with one of the product or the service, to thereby determine whether the predetermined condition is satisfied.

(3)

The system according to Item (1) or (2), further including a benefit granting module configured to grant a benefit relating to one of the product or the service to the user based on the user's actions in the game.

(4)

The system according to any one of Items (1) to (3), wherein the processing execution module is configured to execute the processing for adding one of the product or the service to a shopping cart of the user account when the predetermined condition is determined to be satisfied.

(5)

The system according to any one of Items (1) to (4), further including a necessity selection module configured to allow the user to select, in the game, necessity of association between the user account and one of the product or the service when the predetermined condition is determined to be satisfied,
wherein the processing execution module is configured to execute the processing based on a selection result of the necessity made in the game when the predetermined condition is determined to be satisfied.

(6)

The system according to any one of Items (1) to (5), further including a necessity selection module configured to allow the user to select, after an end of the game, necessity of association between the user account and one of the product or the service when the predetermined condition is determined to be satisfied,
wherein the processing execution module is configured to execute the processing based on a selection result of the necessity made after the end of the game when the predetermined condition is determined to be satisfied.

(7)

The system according to any one of Items (1) to (6), further including a guide module configured to guide the user to a screen for the electronic commerce relating to one of the product or the service associated with the user account by the processing after an end of the game.

(8)

The system according to any one of Items (1) to (7), further including a level increase module configured to increase a level of the game when the user has made a transaction relating to one of the product or the service associated with the user account by the processing.

(9)

The system according to any one of Items (1) to (8),
wherein the determination module is configured to determine whether the predetermined condition for each of a plurality of electronic commerce systems is satisfied based on the user's actions in the game, and
wherein the processing execution module is configured to execute the processing for one of the plurality of electronic commerce systems for which the predetermined condition is determined to be satisfied.

(10)

The system according to Item (9), wherein the game execution module is configured to display, in the game, information that enables identifying one of the plurality of electronic commerce systems that is associated with the predetermined condition.

(11)

The system according to any one of Items (1) to (10),
wherein the game execution module is configured to execute one of the game or a game part selected by the user from among one of the games or game parts of each of a plurality of electronic commerce systems,
wherein the determination module is configured to determine whether the predetermined condition of one of the game or the game part selected by the user is satisfied based on the user's actions in the game in one of the game or the game part selected by the user, and
wherein the processing execution module is configured to execute the processing for one of the plurality of electronic commerce systems that corresponds to one of the game or the game part selected by the user.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A system, comprising at least one processor configured to:
execute a game based on user's actions;
determine whether a predetermined condition associated with one of a product or a service in electronic commerce is satisfied based on the user's actions in the game; and
execute processing for listing one of the product or the service with a candidate list of a user account of the user in the electronic commerce when the predetermined condition is determined to be satisfied.

2. The system according to claim 1, wherein the at least one processor is configured to determine, based on the user's actions in the game, whether the user has acquired an object in the game associated with one of the product or the service, to thereby determine whether the predetermined condition is satisfied.

3. The system according to claim 1, wherein the at least one processor is configured to grant a benefit relating to one of the product or the service to the user based on the user's actions in the game.

4. The system according to claim 1, wherein the at least one processor is configured to execute the processing for adding one of the product or the service to a shopping cart of the user account when the predetermined condition is determined to be satisfied.

5. The system according to claim 1, wherein the at least one processor is configured to:
allow the user to select, in the game, necessity of association between the user account and one of the product or the service when the predetermined condition is determined to be satisfied; and
execute the processing based on a selection result of the necessity made in the game when the predetermined condition is determined to be satisfied.

6. The system according to claim 1, wherein the at least one processor is configured to:
allow the user to select, after an end of the game, necessity of association between the user account and one of the product or the service when the predetermined condition is determined to be satisfied; and
execute the processing based on a selection result of the necessity made after the end of the game when the predetermined condition is determined to be satisfied.

7. The system according to claim 1, wherein the at least one processor is configured to guide the user to a screen for the electronic commerce relating to one of the product or the service associated with the user account by the processing after an end of the game.

8. The system according to claim 1, wherein the at least one processor is configured to increase a level of the game when the user has made a transaction relating to one of the product or the service associated with the user account by the processing.

9. The system according to claim 1, wherein the at least one processor is configured to:
determine whether the predetermined condition for each of a plurality of electronic commerce systems is satisfied based on the user's actions in the game; and
execute the processing for one of the plurality of electronic commerce systems for which the predetermined condition is determined to be satisfied.

10. The system according to claim 8, wherein the at least one processor is configured to display, in the game, information that enables identifying one of a plurality of electronic commerce systems that is associated with the predetermined condition.

11. The system according to claim 1, wherein the at least one processor is configured to:
execute one of the game or a game part selected by the user from among one of the games or game parts of each of a plurality of electronic commerce systems;
determine whether the predetermined condition of one of the game or the game part selected by the user is satisfied based on the user's actions in the game in one of the game or the game part selected by the user; and
execute the processing for one of the plurality of electronic commerce systems that corresponds to one of the game or the game part selected by the user.

12. A method, comprising:
executing a game based on a user's actions;
determining whether a predetermined condition associated with one of a product or a service in electronic commerce is satisfied based on the user's actions in the game; and
executing processing for listing one of the product or the service with a candidate list of a user account of the user in the electronic commerce when the predetermined condition is determined to be satisfied.

13. A non-transitory information storage medium having stored thereon a program for causing a computer to:
execute a game based on a user's actions;
determine whether a predetermined condition associated with one of a product or a service in electronic commerce is satisfied based on the user's actions in the game; and
execute processing for listing one of the product or the service with a candidate list of a user account of the user in the electronic commerce when the predetermined condition is determined to be satisfied.
